(19) United States
(12) Patent Application Publication
(10) Pub. No.: US 2015/0106204 A1
(43) Pub. Date: Apr. 16, 2015

(54) METHODS FOR PROVIDING A VEHICLE WITH FUEL PURCHASING OPTIONS

(71) Applicant: General Motors LLC, Detroit, MI (US)

(72) Inventor: Nikola J. Pudar, Farmington Hills, MI (US)

(73) Assignee: General Motors LLC, Detroit, MI (US)

(21) Appl. No.: 14/051,760

(22) Filed: Oct. 11, 2013

(51) Int. Cl. G06Q 30/02

(52) U.S. Cl. CPC G06Q 30/0269; G06Q 30/0261; G06Q 30/0272
USPC 705/14.58

(57) ABSTRACT

In an example of a method for providing a vehicle with fuel purchasing options, vehicle data and a request for a fuel price is received at a server from a vehicle communications platform disposed in the vehicle. The vehicle data includes a vehicle identifier and a current location of the vehicle. A plurality of fuel retailers within a preset deviation around the current location of the vehicle are identified, where the preset deviation is associated with a distance that is drivable by the vehicle based on a current fuel level of the vehicle. Offers from the plurality of fuel retailers are determined based on a respective travel time to each of the fuel retailers and an amount of fuel needed by the vehicle. The offers are valid for a set period of time. The offers are transmitted to the vehicle communications platform.

### TECHNICAL FIELD

The present disclosure relates generally to methods for providing a vehicle with fuel purchasing options.

### BACKGROUND

Vehicles that run on gasoline or diesel fuel need to be refueled regularly for continued operation. Refueling often occurs when the vehicle is low on fuel, when the fuel level reaches a point at which the user prefers to refuel, when refueling is convenient for the user, or the like. These circumstances often lead to the user making an on-the-fly decision with regard to refueling. This decision could lead to, for example, the use of a relatively more expensive fuel retailer or the vehicle running out of fuel after missing an opportunity to refuel.

### SUMMARY

Methods for providing a vehicle with fuel purchasing options are disclosed herein. In an example of the method, vehicle data and a request for a fuel price is received at a server from a vehicle communications platform disposed in the vehicle. The vehicle data includes a vehicle identifier and a current location of the vehicle, and may, in some instances, include additional information. A plurality of fuel retailers within a preset deviation around the current location of the vehicle are identified, where the preset deviation is associated with a distance that is drivable by the vehicle based on a current fuel level of the vehicle. Offers from the plurality of fuel retailers are determined based on a respective travel time to each of the fuel retailers and an amount of fuel needed by the vehicle. The offers are valid for a set period of time. The offers are transmitted to the vehicle communications platform.

### BRIEF DESCRIPTION OF THE DRAWINGS

Features and advantages of examples of the present disclosure will become apparent by reference to the following detailed description and drawings, in which like reference characters correspond to similar, though perhaps not identical, components. For the sake of brevity, reference characters or features having a previously described function may or may not be described in connection with other drawings in which they appear.

FIG. 1 is a schematic diagram depicting an example of a system for providing a vehicle with fuel purchasing options;

FIG. 2 is a block diagram depicting an example of a client application according to the present disclosure;

FIG. 3 is a block diagram depicting an example of a server according to an example of the present disclosure;

FIGS. 4A and 4B are schematic diagrams depicting examples of preset deviations around a current location of the vehicle;

FIG. 5 is a schematic diagram depicting an example of the identification of fuel retailers;

FIG. 6 is a flow diagram depicting an example of a “Find Me Gas” process; and

FIG. 7 is a flow diagram depicting an additional example of a “Find Me Gas” process.

### DETAILED DESCRIPTION

Example(s) of the method disclosed herein may be used to provide real-time discounted fuel prices or other promotions/incentives to a vehicle through a program (referred to herein as a “Find Me Gas” program). The offers are offered by fuel retailer(s) that participate in the program and are located within a convenient proximity of the vehicle. The offers are presented to the vehicle by a service provider working in conjunction with the fuel retailer(s) through the program. In some instances, the method(s) enable a vehicle driver to find cheaper fuel when it is needed. As examples, when the vehicle is low on fuel, or the vehicle is entering an area where few fuel retailers are available, or the user/driver is planning a trip, the user/driver may rely on the real-time discounted fuel prices offered by the fuel retailers to plan ahead where to stop for fuel. The fuel retailers may also benefit from the examples disclosed herein, for example, through potential increased sales of fuel and secondary merchandise, and potential saving on marketing expenses.

As mentioned above, in at least some of the examples disclosed herein, the fuel retailer is identified because it is within a “convenient proximity” of the traveling vehicle. The fuel retailer(s) may be determined to be within a convenient proximity of the vehicle when the total impact on the vehicle's travel time is minimal (i.e., below some threshold level) or non-existent. Computer-readable code/instructions that identify the fuel retailer(s) may take into account the location of the vehicle, the location(s) of the fuel retailer(s) with respect to the vehicle and/or with respect to other fuel retailer(s), the level of fuel in the vehicle, the vehicle heading, the type of fuel the vehicle is capable of consuming, crime statistics of a fuel retailer location, and/or country boarder (e.g., if the vehicle is in a city (e.g., Detroit) that is near another country (e.g., Canada). For one example, fuel retailer(s) that is/are located on the road upon which the vehicle is travelling, in the direction of travel of the vehicle, and within a reasonable distance (e.g., 0.3 miles or less) of the vehicle's current location may be identified as being within a convenient proximity of the vehicle. For another example, fuel retailer(s) that is/are located in the opposite direction of the vehicle's direction of travel but are within a reasonable distance when compared to the next closest fuel retailer(s) may be identified as being within a convenient proximity of the vehicle. For yet another example, fuel retailer(s) that is/are located some distance off of the vehicle's planned route but is/are the closest fuel retailer(s) taking into account the current fuel level may be identified as being within a convenient proximity of the vehicle. These examples are provided for illustration, and it is to be understood that other scenarios can lead to a fuel retailer being identified as within a convenient proximity of the vehicle.

It is to be understood that, as used herein, the term “user” includes a vehicle owner, a vehicle operator/driver, and/or a vehicle passenger. In instances where the user is the vehicle owner, the term “user” may be used interchangeably with the terms subscriber and/or service subscriber.

Additionally, it is to be understood that, as used herein, the terms “connect/connected/connection” and/or the like are broadly defined to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Further, the term “communication” is to be construed to include all forms of communication, including direct and indirect communication. As such, indirect communication may include communication between two components with additional component(s) located therebetween.

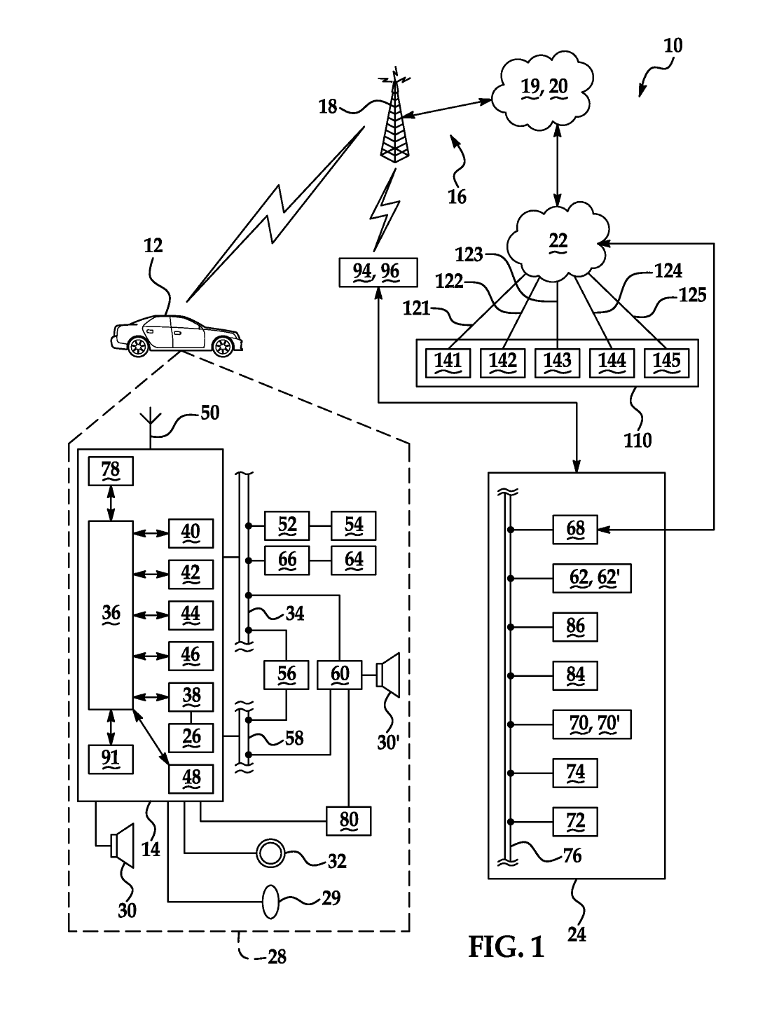

FIG. 1 depicts a system 10 for providing a travelling vehicle 12 with fuel purchasing options. In some instances, the fuel purchasing options may assist the user in a variety of ways, including, for example, in locating the cheapest fuel within the vicinity of the vehicle 12, in locating the closest fuel retailer to the vehicle 12 before the vehicle 12 runs out of gas, or in locating a fuel retailer that is offering a desired promotion on a product other than fuel.

The vehicle 12 may be any vehicle that is capable of being mobile, such as a motorcycle, car, truck, recreational vehicle (RV), boat, plane, etc. The vehicle 12 is equipped with suitable hardware and software that enables it to communicate (e.g., transmit and/or receive voice and data communications) over a carrier/communication system 16 (discussed below).

In an example, the carrier/communication system 16 is a two-way radio frequency communication system. The carrier/communication system 16 may include one or more cell towers 18. It is to be understood that the carrier/communication system 16 may also include one or more base stations and/or mobile switching centers (MSCs) 19 (e.g., for a 2G/3G network), one or more evolved Node Bs (eNodeB) and evolved packet cores (EPC) 20 (for a 4G (LTE) network), and/or one or more land networks 22. The carrier/communication system 16 is part of a cellular radio environment, which may include a variety of wireless network providers (which include mobile network operator(s), not shown), utilizing the same or a variety of radio access technologies.

The carrier/communication system 16 also includes one or more host servers 94 including suitable computer equipment (not shown) upon which information of a remotely accessible page 96 resides. In an example, the remotely accessible page 96 is a webpage set up and maintained by a network (i.e., cellular service) provider or by a telematics service provider. In another example, the remotely accessible page 96 may be a service site and/or account managing site associated with the service center 24.

The overall architecture, setup and operation, as well as many of individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

As mentioned above, the vehicle 12 includes hardware and software that enables it to communicate over the carrier/communication system 16. In one example, this communications hardware and software is part of a vehicle communications platform 14. The vehicle 12 also includes other hardware and software, which are shown generally at reference numeral 28 in FIG. 1. In general, the hardware components are capable of running software, or computer-readable instructions/code, which are embodied on non-transitory, tangible computer-readable media. In any of the examples disclosed herein, the computer-readable media may include any one of many physical media such as, for example, electronic, magnetic, optical, electromagnetic, or semiconductor media. More specific examples of suitable computer-readable media include hard drives, a random access memory (RAM), a read-only memory (ROM), an erasable programmable read-only memory (EPROM), or a portable CD, DVD, or flash drive.

The vehicle communications platform 14 is an onboard device that provides a variety of services, both individually and through its communication with the service center 24 (e.g., a facility that is owned and operated by a vehicle communications service provider). Examples of the vehicle communications platform 14 include a telematics unit, an infotainment unit, or some other similar vehicle dedicated communications device/module, etc.

The vehicle communications platform 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50.

It is to be understood that the vehicle communications platform 14 may be implemented without one or more of the above listed components, such as, for example, the short-range wireless communication network 48. It is to be further understood that vehicle communications platform 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

In an example, the electronic processing device 36 (also referred to herein as a processor) is capable of running software program(s) having computer readable code to initiate and/or perform one or more steps of the examples of the method disclosed herein. For instance, the software program(s) may include a “Find Me Gas” (or other suitably named) client-side application 26 (also referred to herein as “Find Me Gas” client) that is downloaded to or pre-installed in the memory 38 of the vehicle communications platform 14 or in firmware of the vehicle communications platform 14. In an example, the Find Me Gas client is capable of being downloaded from an online application store or marketplace.

The Find Me Gas client 26 generally operates in two modes, including a background mode in which various modules of the application are running in the background to analyze vehicle data and monitor vehicle fuel level, and an interface mode in which the application is launched on the in-vehicle display 80 so that user commands may be received and information may be displayed for the user.

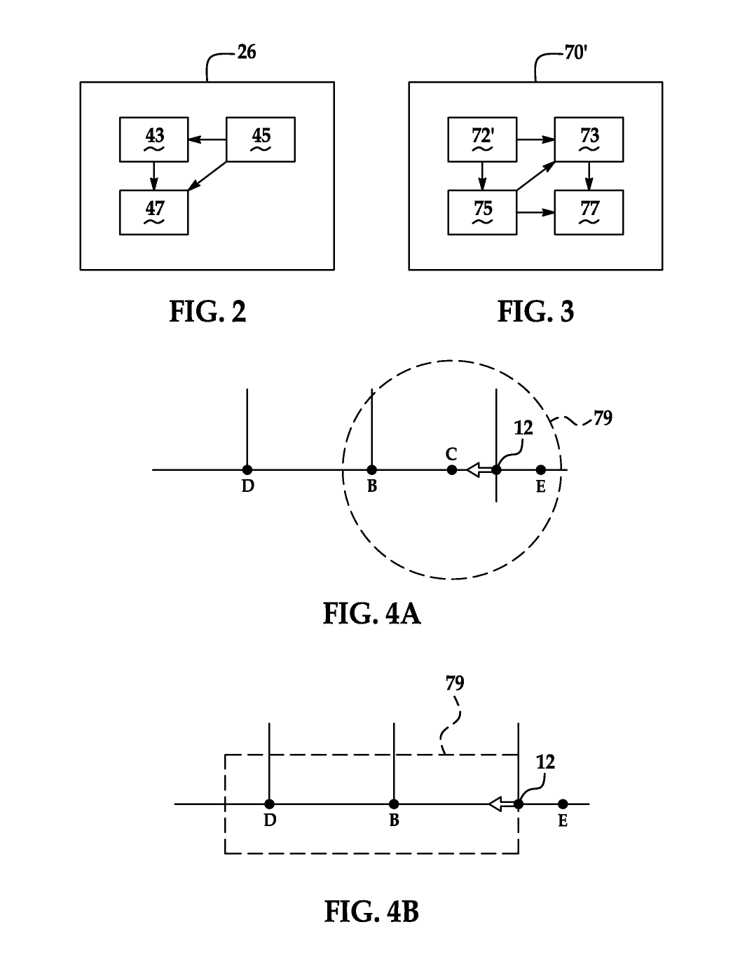

An example of the Find Me Gas client 26 is depicted as a block diagram in FIG. 2. The Find Me Gas client 26 includes a number of modules, which may be implemented as software contained in firmware or in the memory 38. In the example shown in FIG. 2, the Find Me Gas client 26 includes a location module 43 a fuel level module 45, and a client module 47.

The location module 43 may ascertain the current location of the vehicle 12 continuously or at preset intervals (e.g., every second, 5 seconds, etc.). In an example, the location module 43 receives the current location information from the location detection chipset/component 44 of the vehicle communications platform 14. The current location information may include vehicle heading (e.g., speed over ground in knots and course over ground, degrees true) and latitude and longitude coordinates. When heading information is not available from the location detection chipset/component 44, the location module 43 may include an algorithm for calculating the direction of travel using received latitude and longitude coordinates. For example, the data may indicate that at time 0, the vehicle 12 is located at [+40.689060 −74.044636]; and at time 1, the vehicle 12 is located at [+40.067080 −73.978005]. With these coordinates, the location module 43 calculates that the vehicle 12 is traveling from northwest to southeast. These calculations may be performed continuously or at whatever intervals updated coordinates are received so that the Find Me Gas client 26 is utilizing current data.

The location module 43 may also include software that, when executed by the processor 36, operates as an in-vehicle navigation system. The location module generally utilizes data retrieved from the location detection chipset/component 44 and/or data input by a vehicle occupant to provide the occupant with information (such as, e.g., maps, turn-by-turn routes, etc.) pertaining to his/her travels. As will be described in further detail below, the vehicle occupant may, in one example, request a route to a desired destination by inputting the request directly into the display 80 while the Find Me Gas client 26 is in interface mode, and the destination and request will be transmitted to the server 70′. The location module 43 (through the vehicle communications module 14 and the display 80, audio component 60, etc.) can deliver an appropriate navigation instruction or turn-by-turn route for the vehicle occupant.

In another example, the vehicle communications platform 14 includes a separate navigation system (not shown) that is operably connected to the location detection chipset/component 44 and the location module 43. In this example, the Find Me Gas client 26 delivers appropriate navigation instructions or turn-by-turn routes through the separate navigation system.

The fuel level module 45 may ascertain the current fuel level of the vehicle 12 from the fuel level sensor(s). The fuel level data may be received continuously or at preset intervals (e.g., every second, 5 seconds, etc.). In one example, fuel level module 45 may include computer readable code (e.g., an algorithm) for recognizing that the current fuel level is approaching, has hit, or has fallen below a preset minimum threshold. The preset minimum threshold may be a manufacturer set minimum fuel level that is stored in the memory 38. The fuel level module 45 includes an algorithm with steps for identifying the current fuel level, comparing the current fuel level to the preset minimum threshold, and responding if the current fuel level is i) within some preset amount above the present minimum, ii) at the preset minimum, or iii) falls below the preset minimum. The programmed response if i, ii, or iii is recognized is to transmit a trigger command to the client module 47 to initiate a request for a fuel price and/or to generate an in-vehicle fuel alarm.

As illustrated in FIG. 2, the fuel level module 45 is also capable of transmitting the fuel level data to the location module 43. In this example, the location module 43 may include computer readable code (e.g., an algorithm) that utilizes the received fuel level data. More particularly, the algorithm is capable of recognizing that a first fuel retailer is within a distance drivable by the vehicle (based on the current fuel level and vehicle mileage) but that a second fuel retailer (e.g., the next closest fuel retailer) is located beyond that distance. In this example, the location module 43 is programmed with the vehicle's mileage and can receive map information using, for example, its navigational software. The received map information may include the location(s) of any fuel retailers within a preset radius, forward direction, etc. of the vehicle 12. The algorithm is capable of calculating the distance between the vehicle 12 and a first closest fuel retailer and a second closest fuel retailer, and then determining, using the mileage, whether the vehicle can travel to the second closest fuel retailer with the current fuel level. If the location module 43 recognizes that the vehicle 12 could travel to either the first or second closest fuel retailer, the location module 43 will return to monitoring the vehicle location. However, if the location module 43 recognizes that the vehicle 12 will likely run out of gas before travelling to the second closest fuel retailer, the programmed response is to transmit a trigger command to the client module 47 to initiate a request for a fuel price and/or to generate an in-vehicle fuel alarm.

Both the location module 43 and the fuel level module 45 are capable of transmitting data and triggering commands to the client module 47. Upon receiving a triggering command, the client module 47 is programmed to initiate a request for a fuel price and transmit the request to a server 70 (e.g., Find Me Gas server 70′) that is programmed to monitor for such requests and respond to such requests. The request may be transmitted through the vehicle communications platform 14 and a vehicle bus 34 operatively connected thereto.

In some instances the client module 47, upon receiving the triggering command, is also capable of initiating an in-vehicle fuel alarm, which alerts an in-vehicle user that it may be desirable to fuel the vehicle 12. The in-vehicle alarm may be audible, visual, and/or haptic and is indicative of the fact that the fuel level should be replenished.

In addition to the capabilities previously described with respect to the location and fuel level modules 43, 45, the Find Me Gas client 26 may also include computer readable code for transmitting a request for a fuel price to the server 70, 70′ in response to user initiation. In this example, an icon may be present on the in-vehicle display 80 and the user can launch the application 26 and manually (e.g., using a touch screen or keypad or other input device) initiate the fuel price request.

Regardless of how the fuel price request is initiated, it is to be understood that the client module 47 communicates information between the vehicle 12 and the Find Me Gas server 70′. In addition to transmitting a fuel price request, the client module 47 may also transmit vehicle data to the Find Me Gas server 70′ (e.g., using a vehicle data upload unit 91, described below). Examples of the vehicle data include the location data ascertained by the location module 43, the fuel level data ascertained by the fuel level module 45, and the Vehicle Identification Number (retrieved from the memory 38).

The operations of the location module 43 and the fuel level module 45 may be performed while the Find Me Gas client 26 is in background mode. The Find Me Gas client 26 may switch to the interface mode after a fuel price request is transmitted to the Find Me Gas server 70′, after the user initiates the Find Me Gas client 26, or after information is received at the vehicle 12 in response to a transmitted fuel price request.

Referring back to FIG. 1, the Find Me Gas client 26 may be stored on the electronic memory 38. The electronic memory 38 of the vehicle communications platform 14 may be an encrypted memory that is configured to store the computer-readable instructions/code to be executed by the processor 36, data associated with the various systems of the vehicle 12 (i.e., vehicle data), vehicle operations, vehicle user preferences and/or personal information, and the like.

The location detection chipset/component 44 may include a Global Position System (GPS) receiver, a radio triangulation system, a dead reckoning position system, and/or combinations thereof. In particular, a GPS receiver provides accurate time, heading, and latitude and longitude coordinates of the vehicle 12 responsive to a GPS broadcast signal received from a GPS satellite constellation (not shown). The location detection chipset/component 44 may also include, for example, Glonass (i.e., global navigation satellite system), Sbas (i.e., satellite-based augmentation systems), or a D-GPS (differential global positioning system). It is noted that in a rare event where the location detection chipset/component 44 does not provide the vehicle heading information directly, the heading may also be calculated by the processor 36 running the Find Me Gas client 26 which, as previously described, utilizes the vehicle locations obtained from the location detection chipset/component 44.

The cellular chipset/component 40 may be an analog, digital, dual-mode, dual-band, multi-mode and/or multi-band cellular phone. The cellular chipset-component 40 uses one or more prescribed frequencies in standard analog and/or digital bands in the current market for cellular systems. Any suitable protocol may be used, including digital transmission technologies such as TDMA (time division multiple access), CDMA (code division multiple access) and FDMA (frequency-division multiple access). The cellular chipset/component 40 may be configured for use with the architecture of the wireless carrier/communication system 16, which may be, for example, GSM (global system for mobile telecommunications), CDMA2000, UMTS (universal mobile telecommunications system), or LTE (long-term evolution).

The vehicle communications platform 14 may also be configured for short-range wireless communication technologies, such as BLUETOOTH®, dedicated short-range communications (DSRC), or Wi-Fi™. In these instances, the cellular chipset/component 40 may operate in conjunction with the short-range wireless communication unit 48.

The dual mode antenna 50 services the location detection chipset/component 44 and the cellular chipset/component 40.

Also associated with electronic processing device 36 is the previously mentioned real time clock (RTC) 46, which provides accurate date and time information to the vehicle communications platform 14 hardware and software components that may require and/or request such date and time information. In an example, the RTC 46 may provide date and time information periodically, such as, for example, every ten milliseconds.

The vehicle communications platform 14 may also include a vehicle data upload (VDU) system 91, which is configured to receive raw vehicle data from the bus 34, packetize the data, and upload the packetized raw data to the server 70, 70′ at the service center 24 (or other external entity). In an example, the VDU 91 is operatively connected to the processor 36 of the vehicle communications platform 14, and thus is in communication with the Find Me Gas client 26, and with the service center 24 via a bus 34 (described below) and the communication system 16. In another example, the VDU 91 may be the vehicle communications platform's central data system that can include its own modem, processor, and on-board database. The database can be implemented using a separate network attached storage (NAS) device or be located elsewhere, such as in memory 38, as desired. The VDU 91 has an application program that handles all of the vehicle data upload processing, including communication with the service center 24, and the setting and processing of triggers (i.e., preset indicators of when data, etc. are to be uploaded). In an example, the VDU 91 may upload a vehicle identifier (e.g., the vehicle identification number (VIN) of the vehicle 12, the year, make and model, etc.) and the current vehicle location to the service center 24 when prompted in response to a command from the client module 47. For example, when the client module 47 transmits a fuel price request to the server 70′, the client module 47 can also transmit a command to the VDU 91 to transmit the desired vehicle data to the server 70′. The desired vehicle data may be received at the VDU 91 from the client module 47 or can be pulled from one or more vehicle systems. In some instances, the current fuel level data of the vehicle 12 is also transmitted with the vehicle identifier and the current location. In other examples, the vehicle identifier is uploaded from the VDU 91 to the service center 24, where the server 70, 70′ (a) decodes the vehicle identifier to obtain the year, make, model, and option information of the vehicle 12, and/or (b) uses the vehicle identifier to retrieve from a database 72, 72′ the year, make, model, and option information of the vehicle 12 and potentially other data regarding the vehicle 12 and/or its owner.

In another example, the client module 47 of the Find Me Gas client 26 may be configured as a VDU 91, and thus could receive data from the various vehicle system and could packetize and transmit the data to the server 70′.

As illustrated in FIG. 1, the vehicle communications platform 14 also includes an intent engine 78 operatively connected thereto. The intent engine 78 is capable of transmitting a navigational history of the vehicle 12 (e.g., for the life of the vehicle, for a predetermined portion of the life of the vehicle, such as within the last 6 months, year, etc.) to the VDU 91 for uploading to the server 70′. The intent engine 78 may be programmed to transmit this data after a fuel request has been transmitted to the server 70′. The information from the intent engine 78 may be used by the server 70′ (e.g., a location module 73) to infer a destination for the vehicle's current trip. For example, if it is Monday and 8 am and the navigation history from the intent engine shows that every Monday around 8 am for the last 6 months the vehicle 12 has stopped at a coffee shop, the location module 73 can infer that the vehicle's destination will be a coffee shop. The inferred destination can be confirmed by a vehicle user (e.g., after the Find Me Gas client 26 prompts the user in response to a command from the location module 43).

Operatively coupled to the vehicle communications platform 14 is a network connection or vehicle bus 34. Examples of suitable network connections include a controller area network (CAN), a media oriented system transfer (MOST), a local interconnection network (LIN), an Ethernet, and other appropriate connections, such as those that conform with known ISO, SAE, and IEEE standards and specifications, to name a few. The vehicle bus 34 enables the vehicle 12 to send and receive signals from the vehicle communications platform 14 to various units of equipment and systems both outside the vehicle 12 and within the vehicle 12 to perform various functions, such as unlocking a door, executing personal comfort settings, and/or the like. In an example, the vehicle bus 34 also enables the vehicle communications platform 14 to receive data from the various units of equipment and systems of the vehicle 12. Such vehicle data may include, but is not limited to, vehicle year, make and model, location-based data (e.g., a then-current location of the vehicle 12), data pertaining to vehicle operations (e.g., gas mileage, fuel tank level, tire pressure, HVAC system operation, vehicle diagnostic information, urea levels, battery charge state, etc.), and/or the like.

Vehicle communications generally utilize radio transmissions to establish a voice channel with carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein.

In some of the examples disclosed herein, the user is capable of inputting a command to initiate the Find Me Gas client 26, to respond to a prompt of the Find Me Gas client 26, or to perform some other action, and is also capable of receiving information/feedback through the Find Me Gas client 26. Examples of the hardware 28 components that enable these commands and/or information and feedback include a microphone 29, speakers 30, 30′, display 80, and buttons, knobs, switches, keyboards, and/or controls 32. Generally, these hardware 28 components enable the user to communicate with the vehicle communications platform 14 and any other system 10 components in communication with the vehicle communications platform 14.

More particularly, a voice module, via the microphone 29, provides the user with a means for inputting verbal or other auditory commands, and can be equipped with an embedded voice processing unit utilizing human/machine interface (HMI) technology known in the art. Conversely, speakers 30, 30′ provide verbal output to the vehicle occupants and can be either a stand-alone speaker (e.g., speaker 30) specifically dedicated for use with the vehicle communications platform 14 or can be part of a vehicle audio component 60 (e.g., speaker 30′). In either event and as previously mentioned, microphone 29 and speakers 30, 30′ enable vehicle hardware 28 and service center 24 to selectively communicate with the occupants through audible speech.

The one or more buttons, knobs, switches, keyboards, and/or controls 32 can also enable a vehicle occupant to activate or engage one or more of the vehicle hardware components. In one example, one of the buttons 32 may be an electronic pushbutton used to initiate the Find Me Gas client 26, and another of the buttons 32 may be an electronic push button used to initiate voice connection/communication with the service center 24 (whether it be a live advisor 62 or an automated call response system 62′).

In still another example, the user may input commands to and/or receive information, feedback, etc. (e.g., text and/or graphics) from the Find Me Gas client 26 using the display 80. In an example, the display 80 is operatively directly connected to or in communication with the vehicle communications module 14. In another example, the display 80 may be part of the audio component 60 (which is indirectly connected to or in communication with the vehicle communications module 14). A touch screen display enables the user to input commands directly through the display 80 as well as receive information, feedback, etc. Examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

The audio component 60 is operatively connected to the vehicle bus 34 and an audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

Still referring to FIG. 1, the vehicle 12 includes a crash and/or collision detection sensor interface 52 that is/are operatively connected to the vehicle bus 34. Crash sensors 54 provide information to the vehicle communications platform 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, fuel level sensors, charge sensors, gyroscopes, accelerometers, magnetometers, emission detection and/or control sensors, environmental detection sensors, and/or the like. One or more of the sensors 64 enumerated above may be used to obtain the vehicle data for use by the vehicle communications platform 14 or the service center 24 to determine operating conditions (e.g., current fuel level) of the vehicle 12. Non-limiting example sensor interface modules 66 include powertrain control, climate control, body control, and/or the like.

As mentioned above, the wireless carrier/communication system 16 may be used to establish communication between the vehicle 12 and any outside communications device or system (e.g., the server 70, 70′ or other communication component(s) at the service center 24, etc.). As illustrated in FIG. 1, the wireless carrier/communication system 16 (e.g., through the land network 22) may also be used to establish communication between at least a plurality 110 of fuel retailers and the server 70, 70′ of the service center 24.

The land network 22 may be a conventional land-based telecommunications network that is connected to one or more landline telephones and connects wireless carrier/communication network 16 to the service center 24. For example, land network 22 may include a public switched telephone network (PSTN) and/or an Internet protocol (IP) network. It is to be understood that one or more segments of the land network 22 may be implemented in the form of a standard wired network, a fiber or other optical network, a cable network, other wireless networks such as wireless local networks (WLANs) or networks providing broadband wireless access (BWA), or any combination thereof. In an example, the land network 22 is an Internet protocol (IP) network.

As shown in FIG. 1, the land network (e.g., an IP network) enables the plurality 110 of fuel retailers to operatively connect to the server 70′. The plurality 110 of retailers may include any number of fuel retailers that sign up to participate in a fuel purchasing option program associated with the Find Me Gas client 26 (i.e., a “Find Me Gas” program). In the example shown in FIG. 1, five participating fuel retailers are depicted, namely, retailer 141, retailer 142, retailer 143, retailer 144, and retailer 145. Each of the fuel retailers 141, 142, 143, 144, 145 within the plurality 110 may be connected to the land network 22 over respective links 121, 122, 123, 124, 125. The links 121, 122, 123, 124, 125 may be a wired connection, typically found in a local area network configuration (e.g., gigabit Ethernet), or a wireless connection (e.g., cellular or satellite based).

The service center(s) 24 are owned and/or operated by a vehicle communications platform service provider, which may or may not be affiliated with a manufacturer of the vehicle 12. In the examples disclosed herein, the vehicle communications platform service provider runs the fuel purchasing option program (i.e., the Find Me Gas program). Vehicle owners and fuel retailers can sign up to participate in the Find Me Gas program. At least part of the Find Me Gas program is implemented by the server 70′ of the service center 24.

In general, the service center(s) 24 of the vehicle communications platform service provider is/are designed to provide the vehicle hardware 28 and/or the vehicle user with a number of different system back-end functions. According to the example shown in FIG. 1, the service center 24 generally includes one or more switches 68, servers 70, 70′, databases 72, live and/or automated advisors 62, 62′, processing equipment (or processor) 84, a communications module 86 (for receiving, routing, processing communications), as well as a variety of other telecommunication and computer equipment 74 that is known to those skilled in the art. These various vehicle communications platform service provider components are coupled to one another via a network connection or bus 76, such as one similar to the vehicle bus 34 previously described in connection with the vehicle hardware 28.

The processor 84, which is often used in conjunction with the computer equipment 74, is generally equipped with hardware for running suitable software programs enabling the processor 84 to accomplish a variety of service center functions. Some of the various operations of the service center 24 are carried out by one or more computers (e.g., computer equipment 74) programmed to carry out some of the tasks of the service center 24. The computer equipment 74 (including computers) may include a network of servers (including server 70, 70′) coupled to both locally stored and remote databases (e.g., database 72) of any information processed.

While the service center 24 may include multiple servers 70, 70′, the Find Me Gas server 70′ will now be described in more detail in reference to FIG. 3. The Find Me Gas server 70′ is an application server that operates on the service provider side. The Find Me Gas server 70′ is selectively connected to the vehicle 12 and to the participating fuel retailers 141, 142, 143, 144, 145.

The Find Me Gas server 70′ is a system of computer hardware and software that assists in providing fuel purchasing options from the fuel retailers 141, 142, 143, 144, 145 to the vehicle 12. The hardware (which may include processor 84) of the server 70′ runs software (i.e., computer readable code/instructions) that enables the server 70′ to perform many of the steps of the methods disclosed herein. For example, the Find Me Gas server 70′ may include an algorithm for identifying fuel (or other) offers that are available from participating fuel retailers 141, 142, 143, 144, 145 who are within a convenient proximity of the vehicle 12. When running the algorithm, the Find Me Gas server may be configured to perform multiple tasks, such as to process a request from the client module 47, to request vehicle data to be uploaded by VDU 91 of the vehicle 12 or receive data uploaded by the VDU 91, to retrieve fuel retailers' information and/or offers stored in a database (e.g., databases 72, 72′), to prioritize offers according to certain criteria, and/or to transmit offers to the vehicle 12.

As illustrated in FIG. 3, the server 70′ may contain a number of modules which may be implemented in software or hardware that is responsive to instructions contained in firmware or memory (not shown). The server 70′ may include a fuel retailer database 72′, a location module 73, a fuel level module 75, and an offer module 77. It is to be understood that the modules 73, 75, and 77 shown in FIG. 3 could be situated across different physical machines on the server-side.

The fuel retailer database 72′ may be a database designated for storing information specific to the participating fuel retailers 141, 142, 143, 144, 145. A profile may be created for each fuel retailer 141, 142, 143, 144, 145 and may be stored in the database(s) 72′. The fuel retailer information may include, for example, store location(s), store phone number(s), hours of operation, gas grade(s), fuel types (e.g., whether diesel or E85, or a charging station when the method is directed to charging station retailers and offers is available), available amenities (such as convenience store, car wash, ATM, etc.), the brand logo, or any other fuel retailer related information. The fuel retailer database 72′ may also store offer(s) for the participating fuel retailers.

The fuel retailers 141, 142, 143, 144, 145 may have selective access to the database(s) 72′ in order to update the information and/or offers in their profile. In an example, the fuel retailers may enter their information by accessing the remotely accessible webpage 96 set up and maintained by the vehicle communications platform service provider. The fuel retailers 141, 142, 143, 144, 145 may also provide (e.g., via phone, email, or by some other means of communication) the information to an advisor 62, 62′ in order to update their respective profiles.

While some of the fuel retailers 141, 142, 143, 144, 145 participate in the Find Me Gas program, it is noted that not all of the fuel retailers having information stored in the fuel retailer database 72′ participate in the Find Me Gas program. The non-participating fuel retailers may have their current prices stored, but will not have access to the database 72′ and will not be able to submit and save offers that are to be transmitted to the vehicle 12 during examples of the method. The database 72′ may contain a flag field to indicate whether the retailer is a participant or a non-participant of the Find Me Gas program. When identifying fuel retailers and offers during examples of the method disclosed herein, the server 70′ may be programmed to prioritize the retailers so that participating fuel retailers 141, 142, 143, 144, 145 are listed prior to non-participating fuel retailers, or are the only fuel retailers listed in the information that is transmitted to the vehicle 12. The information for the fuel retailers who are not participants of the Find Me Gas program may be entered into the fuel retailer database 72′ by the vehicle communications platform service provider, or the server 70′ may be programmed to automatically pull at least updated fuel prices for non-participating fuel retailers from Internet resources.

The server 70′ is capable of sorting and selecting the information in the fuel retailers database 72′ by city, zip code, location coordinates relative to the vehicle location, etc. More particularly, the modules 73 and 75 are programmed to identify particular fuel retailers (whose profiles are stored in the database 72′) that are within the convenient proximity of the vehicle 12 and/or are long a route that the vehicle is to travel. The identification takes place in response to the fuel pricing request received from the vehicle 12. The offers module 77 is programmed to determine and prioritize the offers to be presented to the vehicle 12. Each of the modules 73, 75, 77 will now be described.

In general, the location module 73 executes location-based services related to the identification of fuel retailers within the convenient proximity of the vehicle 12 or along a trip route, and the fuel level module 75 computes an estimated time and distance that the vehicle 12 may be able to travel based on the current fuel level. The modules 73 and 75 are in communication with one another so that the estimated travel time and distance can be transmitted from the fuel level module 75 to the location module 73. The respective modules 73 and 75 receive vehicle data (e.g., VIN or other identifier, current vehicle location, current vehicle fuel level, etc.) in the packet data that is transmitted from the VDU 91 and unpacketized and distributed by the processor (e.g., 84) associated with the server 70′.

Upon receiving the information from the VDU 91, the fuel level module 75 can decode the vehicle identifier to obtain other vehicle information (e.g., year, make, model, options, etc.) or can use the identifier to look up other vehicle information, such as, for example, the year, make, model, and options of the vehicle 12, the type of fuel the vehicle consumes, and the fuel tank size of the vehicle 12. When the identifier is used for looking up additional information, the additional information may be retrieved from the database 72, which includes user and vehicle profiles. Using the fuel tank size, the fuel level module 75 can subtract the current fuel level from the fuel tank size to calculate how much fuel the vehicle 12 needs to fill the tank. This information may be transmitted to the location module 73 and to the offers module 77. The fuel level module 75 may also retrieve the mileage (i.e., miles per gallon (MPG)) of the vehicle 12 from the database 72. As a backup (e.g., in instances of reading errors), the fuel level module 75 may be programmed i) to look up historical data pertaining to the vehicle's mileage in the profile, and ii) to look up values for the vehicle type and engine combination when no historical data is available.

Using the mileage information and the current fuel level, the fuel level module 75 can calculate an estimated distance that the vehicle 12 can travel using the remaining fuel. For example, if the mileage is 25 miles/gallon and the vehicle has about 1.5 gallons remaining in the tank, the calculated travel distance is approximately 37.5 miles. The fuel level module 75 can also estimate the time it will take the vehicle to travel the estimated distance using the current vehicle speed. The speed data may be transmitted with the packet data from the VDU 91 or the fuel level module 75 may be programmed to request such information from the vehicle 12. In the example above, if the current average speed of the vehicle is 70 miles per hour, the estimated vehicle travel time calculated by the fuel level module 75 is about 0.5 hours (i.e., 37.5 miles/(1 hour/70 miles)). The estimated travel distance and time may be transmitted to the location module 73 and to the offers module 77.

The location module 73 includes an algorithm that identifies one or more fuel retailers that are within a preset deviation around the current location of the vehicle, where the preset deviation is based, at least in part, on the estimated travel time and distance supplied by the fuel level module 75. The preset deviation corresponds to some geographic area around the current location of the vehicle 12. In an example, the preset deviation may be calculated using the estimated distance as a radius around the current location of the vehicle 12. The location module 73 may also adjust this circular preset deviation so that the current vehicle location is between the center point and the circumference and the bulk of the area is ahead of the vehicle 12 (see, e.g., FIG. 4A). This modification to the preset deviation will help to ensure that the fuel retailers that are selected are within the convenient proximity of the vehicle 12 (i.e., the vehicle 12 will be more likely to not have to vary from the direction of heading). In another example, the preset deviation may be calculated using the current location as a starting point and generating an end point using the estimated distance. This preset deviation may be in the general heading of the vehicle with some variation in the directions that are perpendicular to the general heading. For example, if the vehicle 12 is headed north, the preset deviation may initially be a geographic area that extends from the current location to some point north of the current location that is the estimated distance from the current location. Since the vehicle 12 is likely to change directions, the location module 73 can alter the initial geographic area by shortening the preset deviation in the north direction and extending the geographic area in both the east and west directions. The location module 73 may use the calculated preset deviation to query the fuel retailer database 72′ for fuel retailers located within the preset deviation.

FIGS. 4A and 4B illustrate two examples of the preset deviation 79 and the fuel retailers identified from the database 72′ utilizing the preset deviation 79. In FIG. 4A, the preset deviation 79 is a circle around a center point C which is some distance ahead of the current location of the vehicle 12 in the direction of travel (denoted by the arrow). The coordinates of the preset deviation 79 may be utilized to retrieve information about fuel retailers B and E, which are both located within the preset deviation. Fuel retailer D will not be identified by the location module 73 in this example, because it is located outside of the preset deviation 79. In FIG. 4B, the preset deviation 79 is a rectangle that extends ahead of the direction of travel (denoted by the arrow) of the vehicle 12. The coordinates of the preset deviation 79 may be utilized to retrieve information about fuel retailers B and D, which are located within the preset deviation. Fuel retailer E will not be identified by the location module 73 in this example, because it is located outside of the preset deviation 79.

The location module 73 may also include an algorithm that identifies fuel retailers between the current location of the vehicle 12 and a destination. The destination may be received from the data transmitted from the vehicle 12 (e.g., after the destination is input by the user). The location module 73 may be programmed to generate or retrieve one or more routes from the vehicle's current location to the input destination. In some examples, the location module 73 selects a shortest route and continues with calculating a number of fueling events along the route and identifying fuel retailers for each of the fueling events. In other examples, the generated or retrieved routes are transmitted to the vehicle communications platform 14 for display on the in-vehicle display 80 and for user selection. The user's selected route is transmitted back to the location module 73 so that the location module 73 can then calculate a number of fueling events along the selected route and identify fuel retailers for each of the fueling events.

When routes are utilizes, the location module 73 is also capable of transmitting turn-by-turn navigational map(s) and audio prompts to the vehicle 12 for output via the in-vehicle display 80 or audio component 60. The location module 73 may include mapping software or may utilize a third-party partner which specializes in mapping and navigation services (e.g., GOOGLE®, MAPQUEST®, etc.)

When a route is selected (either by the location module 73 or the user), the location module 73 is programmed to utilize the current fuel level and the vehicle mileage data to determine a number of fueling events along the route. For example, if the route is a total of 1184.6 miles, the current fuel level is 3 gallons in a 12 gallon tank, and the mileage is 31 mpg, the total trip will require about 38.2 gallons of fuel. Since the current fuel level is 3 gallons, the vehicle will need 35.2 gallons to complete the trip, and with a 12 gallon tank, the amount of fuel will require about 3 refueling events. In this example, the identification of at least one fuel retailer (i.e., the retailers for the first of the fueling events) is based on the estimated travel time and distance supplied by the fuel level module 75. This is so that the vehicle 12 does not run out of gas prior to the first refueling event. Determining the additional fuel retailers for the other refueling events may take into account data that is calculated (e.g., by the fuel level module 75) as the vehicle 12 travels the route and the varying cost of fuel along the route.

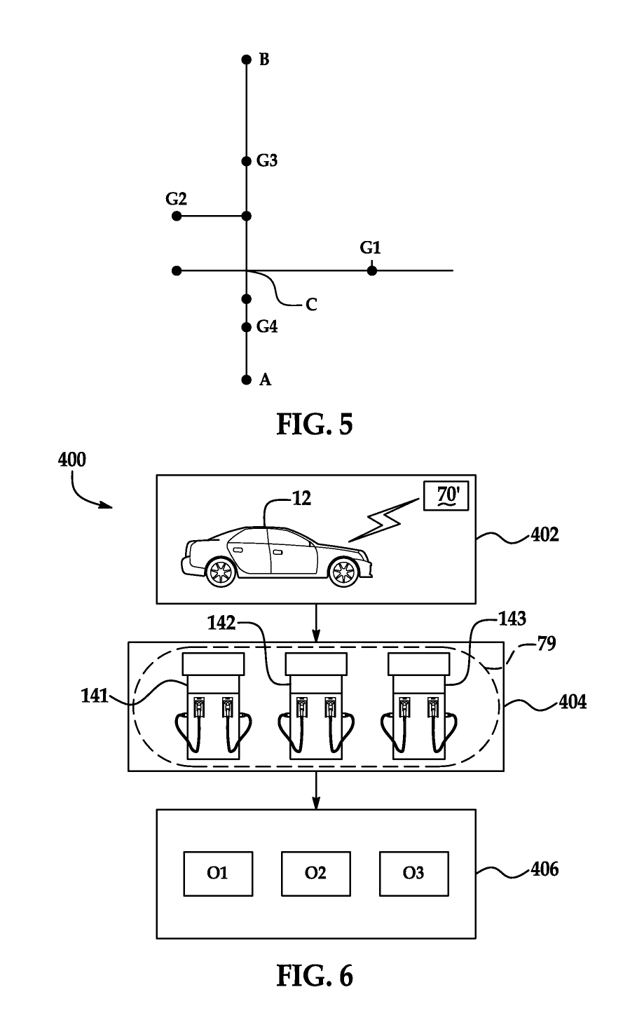

Some routes may be associated with a single fueling event. For example, if the route is relatively short or the amount of fuel in the tank is enough for the vehicle 12 to traverse a portion of the route. When a single fueling event is identified for a particular route, the location module 73 may calculate the preset deviation 79 based upon when the vehicle 12 will likely need to refuel along the route. An example of the preset deviation 79 used for a route is shown in FIG. 5. In FIG. 5, the vehicle (not shown) is traveling from point A to point B. Based upon at least the current fuel level data and the current speed data, the location module 73 may have determined that the preset deviation 79 is 10 minutes of travel time in any direction from point C. The location module 73 may also have determined that fuel retailers G1-G4 sell the vehicle's fuel type. The fuel retailers G2 and G3 are each 10 minutes away from point C, the fuel retailer G1 is 15 minutes from point C, and the fuel retailer G4 is 5 minutes from point C. Using the preset deviation 79 as the search criteria for the database 71′, the location module 73 will not identify fuel retailer G1. The database 72′ will identify the other fuel retailers G2, G3, G4 because they are located within the preset deviation 79 of this example. In this particular example, the offers module 77 (discussed below) may prioritize fuel retailer G4 at the end of the list because using this fuel retainer would require the vehicle 12 to travel backwards in the journey. However, if the offer of fuel retailer G4 is so much cheaper than the offers of furl retailers G2 and G3 or is also associated with a free drink, food item, etc., the offers module 77 may prioritize fuel retailer G4 at the top of the list of offers transmitted to the vehicle 12.

After the initial fuel retailers are identified based upon the preset deviation or the route, the location module 73 can further narrow the suitable fuel retailers to present to the vehicle 12 using a number of factors. In an example, the location module 73 may narrow the number of fuel retailers based upon the type(s) of fuel available at the retailers and the type of fuel consumable by the vehicle 12. In another example, the location module 73 may narrow the number of fuel retailers based upon the type of vehicle 12. For example, fuel retailers may have their respective profiles tagged that they want to be included in the list of retailers when the vehicle is of a certain type (e.g., a specific sports car, a specific year). In yet another example, the location module 73 may narrow the number of the fuel retailers using the same zip code of the current location of the vehicle 12. In still another example, if the vehicle 12 is a semi-truck which runs on diesel fuel, the location module 73 may only ascertain a number of the fuel retailers that offer diesel fuel. The location module 73 may also utilize the location of the fuel retailers and the computed travel time from the current location of the vehicle 12 to each of the fuel retailers to further narrow the list. For example, if multiple fuel retailers are within the preset deviation, but one is 5 seconds behind the current location of the vehicle 12, one is about 5 minutes east of the direction of travel and the third is about 10 minutes in the direction of travel, the location module 73 can determine the impact on the travel time. For example, the fuel retailer that is 5 minutes east may be discarded as being within a convenient proximity because it will take at least 10 minutes for the vehicle 12 to get to and from this fuel retailer. In contrast, it will take less than 1 minute for the vehicle 12 to get to and from the fuel retailer located behind the current location, and thus this fuel retailer may be included as being within convenient proximity of the vehicle 12.

Still other factors that may be taken into account by the location module 43 when narrowing down the list of fuel retailers include traffic information, type of road being traveled, locations of the next closest fueling stations, etc.

The location module 73 transmits the list of fuel retailers to the offers module 77, which includes an algorithm to determine the final offers/discounts from the respective fuel retailers and to prioritize them for presentation to the user in the vehicle 12. The final offers are determined according to actual offers from the fuel retailers that are uploaded to the database 72′ or using a set of rules entered into the database 72′ by the fuel retailers. The actual offers or the preset rules may be entered into the database 72′ (and stored in the respective profiles) by the fuel retailers by accessing the remotely accessible webpage 96 or by calling, email, or otherwise communicating with the advisor 62, 62′.

Actual offers may include fuel prices and coupons for non-fuel merchandise (which include codes for redeeming such merchandise) which are not associated with any rules. For example, a fuel retailer may input a discounted fuel price or coupon code for a free or discounted food/drink that is to be offered to any vehicle 12 in response to a request and the fuel retailer being identified.

The preset rules, however, may be guidelines or thresholds for selecting the offers. For example, a fuel retailer 141, 142, 143, 144, 145 may input rules about fuel prices that are to be offered when the needed fuel amount is over or under some threshold amount, or rules about offering conditional coupons (e.g., when the tank is registering as empty, offer a non-fuel coupon that is redeemable if the vehicle tank is filled), or rules about offering conditional fuel process (e.g., offer price A but note in the offer that if the tank is filled, price B, which is less than price A, will be given), or rules about offering special deals for specific vehicle types, or other similar rules or combinations of rules. As a more specific example, the fuel retailer may input guidelines similar to the following scheme: i) if the vehicle 12 needs more than 8 gallons of fuel to have a full tank, the vehicle may receive 20 cents per gallon off the regular price offered at the fuel retailer at the time on that day; ii) if the vehicle 12 needs more than 5 gallons but less than 8 gallons of fuel to have a full tank, the vehicle may receive 10 cents per gallon off the regular price that the fuel retailer offers at the time on that day; and iii) if the vehicle 12 needs less than 5 gallons of fuel in order to have a full tank, the vehicle may receive an offer for a free drink instead of a discount on the fuel price. As another more specific example, the fuel retailer may input guidelines based on the distance of the vehicle 12 from the fuel retailer (which is calculated by the location module 43 in real-time). For example, the guidelines may include: i) if the vehicle 12 is less than a mile from the fuel retailer, the vehicle may receive a discount on fuel price, and ii) if the vehicle 12 is more than a mile away from the fuel retailer, the fuel retailer may offer the vehicle a free soda in addition to the discount on the fuel price. As still another more specific example, a fuel retailer may input guidelines based on the type of vehicle 12. For example, the guidelines may include i) $0.20 off per gallon for all CADILLAC® brand vehicles, and ii) $0.10 off per gallon for any vehicle taking premium fuel, unless the vehicle is a CADILLAC®, then rule i applies.

The preset rules may also include guidelines for when to transmit certain offer(s). For example, a fuel retailer may have an offer of a certain discount on the fuel price, but may specify that the offer can only be transmitted if the vehicle 12 is of a certain year and make, or is of a certain year and model. For another example, a fuel retailer may offer a discount on an oil change, but only if the vehicle mileage is below a certain threshold mileage. For still another example, a fuel retailer may have an offer for a specific drink (e.g., coffee, soda, etc.), but may specify that the offer can only be transmitted if the vehicle owner information (retrievable by the server 70′ from the database 72) indicates that the vehicle owner is a coffee drinker, owns multiple vehicles, etc. Another other vehicle criteria and/or vehicle owner criteria may be used to identify when the offer(s) may be transmitted to the vehicle communications platform 14.

When rules are in place, it is to be understood that the offers by a single fuel retailer that are transmitted to different vehicles may be the same or different. In one example, vehicle A is a sedan with 10-gallon tank and a vehicle B is a minivan with 20-gallon tank. In this example, both vehicles A and B send the request for the fuel price to the Find Me Gas server 70′ at the same time. Both vehicles A and B are located one mile away from the fuel retailer, and both vehicles have fuel remaining that is equivalent to about 5% of the respective tank's capacity. If the rule in this scenario relates to the number of gallons to be purchase, the sedan may receive 10 cents of discount per gallon, while the minivan may receive 20 cents of discount per gallon (e.g., because the minivan will be purchasing more fuel that, in accordance with the preset rule, entitle the vehicle 12 to the larger discount). In another example, vehicle A has a 10-gallon fuel tank with one gallon left and is one mile away from the fuel retailer, and vehicle B has a 10-gallon tank has one gallon left and is two miles away from the fuel retailer. In this scenario, the rule may be to offer a discounted fuel price to all vehicles and also a free drink if the vehicle is over 1 mile away. As such, the offers module 77 may retrieve an offer for vehicle A that is 10 cents off the regular price, and an offer for vehicle B that includes 10 cents off the regular price plus a free soda. As illustrated by these examples, the fuel retailer may offer varying incentives in order to entice customers to use their establishment.

The offers may be associated with an expiration period, and thus may be effective only for a set period of time. The expiration time for the offers is set up by the fuel retailers. If an offer is expired, the offers module 77 will be programmed to either not transmit the offer, or to select a default offer that the fuel retailer has saved in its profile. The offers module 77 may also be programmed to transmit a message to the fuel retailer informing them that their profile has an expired offer therein.

The offers module 77 is also programmed to prioritize the offers that are to be sent to the vehicle 12. The offer module 77 may be programmed to retrieve any offers associated with the fuel retailer(s) that are on the list transmitted by the location module 43. The offers module 77 prioritizes the offers for transmission to the vehicle display 40 by price (e.g., cheapest to most expensive), by convenient proximity (e.g., fastest and/or closest to slowest and/or furthest), by incentives (e.g., those that are offering a reduced fuel price in combination with a merchandise offer to those that are associated with no special offer), etc. The offers module 77 can also recognize when the request is in conjunction with a trip, and can transmit the offers at appropriate times along the trip (e.g., a first set of offers is related to a first refueling event and a second set of offers is related to a second refueling event later in the trip).

Table 1 illustrates an example of how the offers module 77 may prioritize and present the offers to the user via the vehicle display 80.

TABLE 1

| | Approximate | | | | | |
|---|---|---|---|---|---|---|
| | Miles from | | | | | |
| | Current | | Dis- | Offer | | Special |
| | Location | Price | count | expires in | | offers |
| Fuel | 0.2 | $3.77 | −$0.22 | 23 | minutes | 1-liter pop |
| Retailer A | | | | | | for $0.99 |
| 123 Sunset | | | | | | |
| Blvd, Troy | | | | | | |
| Fuel | 0.2 | $3.86 | −$0.30 | 30 | minutes | Large |
| Retailer B, | | | | | | coffee |
| 100 College | | | | | | for $0.99 |
| Way, Troy | | | | | | |
| Fuel | 0.3 | $3.72 | | | | |
| Retailer C, | | | | | | |
| 10 John R. | | | | | | |
| Road, Troy | | | | | | |
| Fuel | 0.5 | $3.76 | −$0.33 | 5 | hours | |
| Retailer D, | | | | | | |
| 500 Michigan | | | | | | |
| Ave., Troy | | | | | | |
| Fuel | 1.5 | $3.85 | | | | |
| Retailer E, | | | | | | |
| 200 S. | | | | | | |
| University | | | | | | |
| Ave., Troy | | | | | | |

As shown in Table 1, a plurality of offers has been presented to the user, and the offers are prioritized by the special offers that are being presented. In the first column, the name and the location of the fuel retailers are shown. In the second column, the distance of the fuel retailer from the current location is shown in miles (although travel time could also be shown). In another example, the offers could be sorted and displayed by whichever fuel retailer is fastest or the closest to the current location of the vehicle. The third column shows the regular price currently offered at the respective fuel retailer, and the fourth column shows the discount the vehicle would get at the time the vehicle arrives at the fuel retailer. In another example, the offers could be sorted according to the fuel price savings. The fifth column shows the time of expiration of the offer. Finally, the last column shows any special offer presented at the fuel retailer presently.

Still referring to FIG. 1, it is to be appreciated that the service center 24 may be any central or remote facility, manned or unmanned, mobile or fixed, to or from which it is desirable to exchange voice and data communications. As such, the live advisor 62 may be physically present at the service center 24 or may be located remote from the service center 24 while communicating therethrough.

The service center 24 shown in FIG. 1 may also be virtualized and configured in a Cloud Computer, that is, in an Internet-based computing environment. For example, the computer equipment 74 may be accessed as a Cloud platform service, or PaaS (Platform as a Service), utilizing Cloud infrastructure rather than hosting computer equipment 74 at the service center 24. The database(s) 72 and server(s) 70 may also be virtualized as a Cloud resource. The Cloud infrastructure, known as IaaS (Infrastructure as a Service), typically utilizes a platform virtualization environment as a service, which may include components such as the processor 84, database(s) 72, server(s) 70, and computer equipment 75. In an example, the Find Me Gas program described herein may be performed, at least partially, in the Cloud via the SaaS (Software as a Service). Subscribers, in this fashion, may access any related software applications (e.g., user-setting pages) remotely via the Cloud. Further, subscriber service requests may be acted upon by the automated advisor 62, which may be configured as a service present in the Cloud.

As mentioned above, the cellular radio environment (or satellite based environment) that includes the carrier/communication system 16 may also include a variety of wireless network providers. Each wireless network provider includes a mobile network operator that monitors and maintains the operation of the communications network associated with that provider. The network operator directs and routes calls, and troubleshoots hardware (cables, routers, network switches, hubs, network adaptors), software, and transmission problems. It is to be understood that, although the wireless network provider may have back-end equipment, employees, etc. located at the vehicle communications platform service provider service center 24, the vehicle communications platform service provider is a separate and distinct entity from the wireless network provider(s). In an example, the equipment, employees, etc. of the wireless network provider(s) are located remote from the service center 24. The wireless network provider provides the user with telephone and/or Internet services, while the vehicle communications platform service provider provides a variety of vehicle communications platform-related services (such as, for example, those discussed hereinabove). It is to be understood that the wireless network provider(s) may interact with the service center 24 to provide services (such as emergency services) to the user.

The system 10 shown in FIG. 1 may be used in a number of different methods for providing the vehicle 12 with fuel purchasing options. While the examples disclosed herein utilize the vehicle communication module 14, the Find Me Gas client 26 could reside on a mobile communications device (not shown) which can communicate with the vehicle communication module 14 via short range wireless technology and with the server 70′ over any suitable communication system (e.g., system 16). Examples of mobile device include a smart phone, a laptop or tablet computer, or the like. Examples of the Find Me Gas program and how it may be carried out will now be described in detail. As stated above, such examples will be described using the system 10 described in detail previously.

The vehicle users and the participating fuel retailers 141, 142, 143, 144, 145 will have signed up to participate in the Find Me Gas program, and thus will have a registered account with the service center 24. As used herein, the term “account” refers to a representation of a business relationship established between the user or fuel retailer 141, 142, 143, 144, 145 and the owner of the service center(s) 24, where such business relationship enables the user to request and receive services (e.g., fuel price offers and non-fuel related offers) through the service center 24 and enables the fuel retailers 141, 142, 143, 144, 145 to submit offers to users through the service center 24. The business relationship may be referred to as a subscription agreement/contract between the user or fuel retailer 141, 142, 143, 144, 145 and the owner of the service center 24, where such agreement generally includes, for example, the type of services, the cost to participate in the program or for such services, the duration of the agreement (e.g., a one-year contract, etc.), and/or the like.

In an example, any account may be set up by calling the service center 24 (e.g., by dialing a phone number for the service center 24) and requesting to (or selecting from a set of menu options) to speak with an advisor 62 to set up an account. In an example, the switch 68 at the service center 24 routes the call to an appropriate advisor 62, who will assist the fuel retailer and/or user with opening and/or setting up the account.

Alternatively, the fuel retailer or vehicle user may also access the remotely accessible page 96 to set up an account. On the remote accessible page 96, there may be two entry points available for setting up an account. One of the entry points is for the user, i.e., the driver of the vehicle 12, and the other entry point is for the fuel retailers 141, 142, 143, 144, 145. On the remotely accessible page 96, the user or the fuel retailer 141, 142, 143, 144, 145 may fill out the requested information through an online form. On the form, the user or fuel retailer may be asked to provide the same information that would be asked by the advisor 62 during a call. The fuel retailer information may include the store name, the store owner's name, store locations, business phone number, hours of operation, gas grades, whether diesel or E85 is available at the location, amenities available at the locations (e.g., convenience store, car wash, air pump, ATM, etc.), and the like. The user information may include personal information, vehicle information, etc. Once the account is set up, the user and/or fuel retailer may enter into a contract or some agreement with the vehicle communications platform service provider to participate in the Find Me Gas program.

During the account setup or any time after, the fuel retailers 141, 142, 143, 144, 145 may also set up offers and/or the set of rules for the offers.

After an account is created, the user information is stored in a profile in the database 72 and the fuel retailer's information, rule(s), and offer(s) are stored in the fuel retailer database 72′ at the service center 24 (as shown in FIG. 3). The fuel retailer will be listed as one of the participants of “Find Me Gas” program. The information of the participant fuel retailers may show up in the search results run by the Find Me Gas server 70′ in response to the fuel price request. It is to be understood that the information of the fuel retailers who are not the participants of the Find Me Gas program (the non-participants) may also show up in the search results. However, the fuel prices of the non-participants are standard available prices, and cannot be altered as incentive prices or coupled with any other special offers.

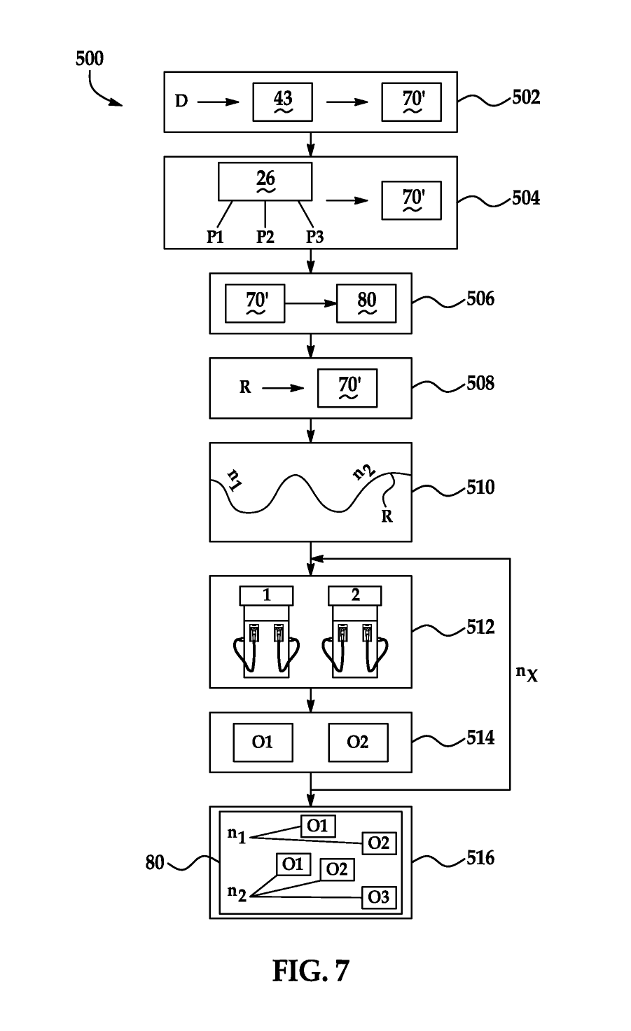

The examples of the method disclosed herein (as depicted in FIGS. 6 and 7) may be accomplished so long as an account has been set up with the service center 24 for the user and the user has joined the Find Me Gas program provided by the service center 24.

Once the user has signed up to participate, the Find Me Gas client 26 may be downloaded from a webpage (e.g., an online application store) operated and/or owned by a facility other than the telematics service provider. In this case, the vehicle communications platform service provider may have entered into an agreement with the facility to create, sell and/or distribute the application 26 that may be downloaded to the vehicle communications platform 14.

Once the Find Me Gas client 26 has been downloaded or installed on the vehicle communications platform 14, the fuel price request may be transmitted automatically as previously described (e.g., low fuel level recognized, alone or in conjunction with location(s) of fuel retailer(s) being beyond a drivable distance), or the user may launch the Find Me Gas client 26 manually. When a request is automatically initiated, the resulting fuel price request may be a “Find Me Gas Now” request, and when the user inputs a destination using the Find Me Gas client, a “Find Me Gas for My Trip” fuel price request may be transmitted. Vehicle data will also be transmitted with the request. The server 70′ will receive the request and the data, and the location module 73 and fuel level module 75 will recognize the different request and respond accordingly. FIG. 6 illustrates an example of the method when a Find Me Gas Now request is transmitted and FIG. 7 illustrates an example of the method when a Find Me Gas for My Trip request is transmitted.

Referring to FIG. 6, the method 400 includes, as shown at reference numeral 402, the vehicle 12 recognizing that the fuel level is below a threshold level, and the Find Me Gas client 26 automatically transmits a Find Me Gas Now request to the server 70′. The location module 73, in conjunction with the fuel level module 75, will identify a preset deviation 79 and will identify a number of fuel retailers 141, 142, 143 that within the preset deviation 79 (represented by reference numeral 404), and also deemed to be within convenient proximity to the vehicle 12.

As previously described, the most convenient fuel retailers may not be the same as the closest fuel retailers to the current location of the vehicle 12. In an example, one fuel retailer 141 may be the closest to the current location of the vehicle 12 but the vehicle 12 may have to change the direction of travel and pass a busy intersection to get there. The typical wait time at the traffic light of the busy intersection may be relatively long. There may be a second fuel retailer 142 located farther from the current location of the vehicle 12 but in the direction of travel of the vehicle and on a less busy street than the street on which the fuel retailer 141 is located. The vehicle 12 may not need to pass an intersection to get to the second fuel retailer 142. As such, the time to get to the second fuel retailer 142 may be shorter than the time it would take to get to the first fuel retailer 141. Therefore, the second fuel retailer may be considered by the location module 73 to be the most convenient fuel retailer at the time. This information may be transmitted to the offers module 77, which can use the information when prioritizing the offers of the fuel retailers 141, 142, 143 for transmission to the vehicle 12.

Upon identifying a selection of eligible fuel retailers 141, 142, 143, the offers module 77 may determine the offers O1, O2, O3 that are available from each fuel retailer 141, 142, 143 (as shown at reference numeral 406). The offers module 77 may retrieve the respective offers O1, O2, O3 from the profiles of the respective fuel retailers 141, 142, 143 in the database 72′. When offer rules are saved in the profile(s), the offers module 77 may be programmed to follow the rules in order to determine which offer(s) to transmit. For example, if the rule of fuel retailer 141 is to offer a price of X when the number of gallons to be purchased is above some number Y and to offer a price of Z when the number of gallons to be purchased is below the number Y, the offers module 77 reviews the current fuel level and the tank capacity to determine if the fuel purchase will be above or below the number Y. The offers module 77 will then select the price X or Z for fuel retailer 141 to transmit to the vehicle display 80. Similarly, if a set price or coupon or combinations thereof are stored in a profile, the offers module 77 will retrieve the offer O1, O2, O3 for each fuel retailer 141, 142, 143 for transmission to the vehicle 12.

As previously described, the offers module 77 will prioritize the offers O1, O2, O3 according to price, convenient proximity, etc., and send the prioritized list to the vehicle 12 for display on the in-vehicle display 80.

Another example of the method disclosed herein will now be described in detail with reference to FIG. 7. FIG. 7 illustrates an example of the method 500 when the Find Me Gas for My Trip request is transmitted from the vehicle 12 to the server 70′. In this case, the user may be planning a trip to a destination (shown as D at reference numeral 502 of FIG. 7). The user's vehicle 12 may not have low fuel level at the time of planning The user may press a button or use a touch screen of the display 80 to start the Find Me Gas client 26. Once the client 26 is launched, the user is presented with an interface and is able to select an icon labeled, for example “Find Me Gas for My Trip”. Once the user selects this option, the user is prompted to enter a destination D for the trip (as shown by reference numeral 502 in FIG. 7).

The destination D may be entered via the display 80 by entering a destination address, name, etc. or by selecting a destination of an address stored in the memory 38. The location module 43 will receive the destination and transmit it to the client module 47 for transmission to the server 70′. If the user fails to enter a destination D within a preset period of time, the client 26, using the intent engine 78, may infer a destination D based on the past driving pattern and behavior of the vehicle 12.

Once the destination D is entered, the Find Me Gas client 70′ may present the user with a selection of preferences P1, P2, P3 for the route(s) (as shown by reference numeral 504 in FIG. 7). The preferences presented allow the user to select the type of route that he/she is looking for or would prefer for the particular trip. For example, the user may be able to select that the route to be presented be the shortest distance route, the fastest route (noting that this might not be the same as the shortest distance route), the cheapest route (taking into consideration of average fuel prices along the route, toll booths, etc.), the route with most use of freeways/highways/expressways, etc., or an ordinary route (which will take into account of driving habits and history received from the intent engine 78). The user may also indicate that he/she has no preference, and thus a selection of available routes will be presented to the user. The selection may include all routes mentioned above.

Any preferences input by the user are transmitted to the server 70′ (in particular, to the location module 73), which generates or retrieves route(s) from the current vehicle location to the destination D in accordance with any received preferences.

If a single route is generated, the method 500 will continue at reference numeral 510 (discussed below). If multiple routes are generated but a user profile indicates that a default route (such as the shortest distance route) is to always be selected, the method 500 will continue at reference numeral 510. However, if multiple routes are generated and there is no indication to select a default route, each route will be transmitted to the display 80, as shown at reference numeral 506. The user will be presented with the selection of routes. In an example, the routes may be presented on a map by the location module 43 of the Find Me Gas client 26. With each route, the distance between the location of the vehicle 12 and the location of the destination D along the route and estimated travel time may be calculated (by the modules 73, 75 or the modules 43, 45) and presented at the same time as the routes are presented.

The user may choose any one route R to proceed with (as shown by reference numeral 508 in FIG. 7). This selection will be transmitted back to the server 70′.

In this example of the method 500, the location module 73 is programmed to utilize the current fuel level and the vehicle mileage data to determine a number of fueling events n₁, n₂ along the route R. As described above, the number of fueling events may be calculated using the total miles to complete the route, the current fuel level, the vehicle mileage, and the fuel tank capacity. In the example shown in FIG. 7, two fueling events may be calculated for the route R.

The fueling event n₁, n₂ may be used to generate different refueling event plans. For example, the location module 73 and fuel level module 75 can review the cost of fuel at different locations along the route R and can generate different plans for the refueling of the vehicle 12, which takes into account the current fuel level (i.e., at the outset for the route), because this will impact the timing of the first fueling event (i.e., before the vehicle 12 runs out of gas). For example, if the vehicle 12 to travel the route R (e.g., 500 miles through states A, B, and C) requires two refueling events, n₁, n₂, and the vehicle 12 currently has 3 gallons and can drive 31 miles per gallon, the following two refueling event plans may be generated:

1) drive 92 miles and then refuel in state B (average fuel cost $3.50), and then drive 370 miles and refuel in state C (average fuel cost $4.00), and then complete route−total cost ˜$82.50; or

2) fill vehicle 12 before leaving state A (average fuel cost $3.40), drive 341 miles, and then refuel in state C (average fuel cost $4.00), and then complete route−total cost ˜$74.6.

For each plan, fuel retailers (e.g., fuel stations 1 and 2 in FIG. 7) and offers (e.g., O1 and O2) may be identified for each refueling event n₁, n₂ (shown at reference numerals 512 and 514), and the offers may be incorporated into the approximate cost associated with the plans. Since the route R is not yet being traversed, the vehicle's location can be estimated for each fueling event. For example, for plan A, the location module 43 can estimate that 92 miles from the current location will be in city F of state B and the location module 92 can identify a preset deviation from the route R within city F. Fuel retailers and their offers may be identified using this criteria, and any savings from the offers may be incorporated into the total cost. Similar estimations and calculations may be performed for each plan and for each refueling event n₁, n₂ within the plans.

These plans may be presented to the user (via the display 80) and the user can select which plan he/she would like to implement. Generally, the plans will be presented in the order of most economical to least economical based on the total cost. The individual projected offers at each refueling event n₁, n₂ may also be presented at this point, however, it is noted that these offers are merely estimates at this point because the actual traveled route may change and the offers may be updated. In some instances, a user may input his/her selection and this will be transmitted back to the server 70′.

The respective offers associated with the selected plan and refueling events n₁, n₂ may then be transmitted as the vehicle 12 travels the route R (as shown in reference numeral 516). For example, as the vehicle approaches the location associated with the preset deviation for refueling event n₁, the offers from the fuel retailers within the preset deviation may be presented. The server 70′ will continuously receive vehicle data as the vehicle 12 travels the route R, and once the vehicle 12 arrives at the estimated preset deviations (according to the selected plan), the fuel retailers and offers may be updated to ensure that current offers are being transmitted to the vehicle 12 in real time. These individual offers may also be prioritized and transmitted in a manner previously described (e.g., by cheapest fuel price to most expensive fuel price).

Furthermore, as the vehicle 12 travels, the preset deviations may vary, at least in part because the vehicle data will be continuously monitored. For example, if the user varies from the route R to see a point of interest, the fuel level may decrease faster than originally estimated in the selected plan. The refueling event may be dynamically updated and the preset deviation reset according to the then current vehicle data, location, etc.

While not shown, the Find Me Gas client 26 may also have an option for paying for the gas, merchandise, etc. from the vehicle, using a credit card, debit card, etc. on file in the user's profile. Upon receipt of a user command (through the client 26), the server 70′ can submit the payment information to the selected fuel retailer.

While the examples disclosed herein relate to fuel purchasing options, it is to be understood that the system 10 and methods disclosed herein may be altered for hybrid and/or electric vehicles. Instead of fuel purchasing options in these examples, the options are charging options. The calculations disclosed herein would be similar, except that current charge level would be utilized instead of current fuel level and voltage levels available at the charging sites would also be obtained (as this impacts total recharging time).

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

1. A method for providing a vehicle with fuel purchasing options, the method comprising:
receiving, at a server, vehicle data and a request for a fuel price from a vehicle communications platform disposed in the vehicle, the vehicle data including a vehicle identifier and a current location of the vehicle;
identifying a plurality of fuel retailers within a preset deviation around the current location of the vehicle, where the preset deviation is associated with a distance that is drivable by the vehicle based on a current fuel level of the vehicle;
determining offers from the plurality of fuel retailers, wherein the offers are valid for a set period of time; and
transmitting the offers to the vehicle communications platform.

2. The method as defined in claim 1 wherein the preset deviation is also associated with a travel time of the vehicle to reach each of the plurality of fuel retailers.

3. The method as defined in claim 1 wherein the vehicle communications platform is a telematics unit disposed in the vehicle.

4. The method as defined in claim 3 wherein prior to the receiving step, the method further comprises:
recognizing, by the telematics unit, that the current fuel level of the vehicle is lower than a preset fuel level; and
in response to the recognizing, automatically initiating the request by the telematics unit.

5. The method as defined in claim 2 wherein prior to the receiving step, the method further comprises:
recognizing, by the telematics unit, that a first available fuel retailer is within the distance that is drivable by the vehicle based on the current fuel level and that a second available fuel retailer exceeds the distance that is drivable by the vehicle based on the current fuel level; and
in response to the recognizing, automatically initiating the request by the telematics unit.

6. The method as defined in claim 5, further comprising generating, by the telematics unit, an in-vehicle alarm indicating that the vehicle should be re-fueled.

7. The method as defined in claim 1 wherein the vehicle identifier is a Vehicle Identification Number, and wherein the method further comprises using the Vehicle Identification Number to determine the offers from the plurality of fuel retailers.

8. The method as defined in claim 7, further comprising obtaining a vehicle mileage using the Vehicle Identification Number.

9. The method as defined in claim 1 wherein the offers are uploaded to the server through a remotely accessible website by the fuel retailers.

10. The method as defined in claim 1, further comprising:
prioritizing, by the server, the offers for display according to an offered fuel price, or a convenient proximal distance from the current location of the vehicle; and
displaying the offers on an in-vehicle display.

11. The method as defined in claim 10 wherein at least one of the offers includes a non-fuel offer, and wherein the non-fuel offer is displayed in addition to an offered fuel price.

12. The method as defined in claim 1, further comprising:
at the server, obtaining, responsive to the vehicle identifier, additional information including any of vehicle year, vehicle make, vehicle model, vehicle options, owner information, or combinations thereof; and
using the additional information to determine the offers from the plurality of fuel retailers.

13. The method as defined in claim 12 wherein the offers are transmitted to the vehicle communications platform only if the vehicle year and vehicle make meet a predetermined criteria.

14. The method as defined in claim 12 wherein the offers are transmitted to the vehicle communications platform only if the vehicle year and vehicle model meet a predetermined criteria.

15. The method as defined in claim 12 wherein the offers are transmitted to the vehicle communications platform only if the vehicle owner information meets a predetermined criteria.

16. A method for providing a vehicle with fuel purchasing options, the method comprising:
receiving, at a server, a destination of travel, vehicle data, and a request for fuel price from a vehicle communications platform disposed in the vehicle, the vehicle data including a vehicle identifier and a current location of the vehicle;
determining, at the server, a route between the current location of the vehicle and the destination;
calculating, at the server, a number of refueling events to enable the vehicle to complete the route;
identifying a number of fuel retailer offers for use between the current location of the vehicle and the destination, wherein each of the number of refueling events is associated with at least one of the number of fuel retailer offers, and wherein a fuel retailer associated with each of the fuel retailer offers is located within a preset deviation from the determined route;
calculating, at the server, a total cost of fuel to complete the route utilizing the number of fuel retailer offers;
prioritizing the number of fuel retailer offers according to the total cost calculation; and
transmitting the prioritized number of fuel retailer offers to the vehicle communications platform.

17. The method as defined in claim 16 wherein the vehicle identifier is a Vehicle Identification Number, and wherein the method further comprises using the Vehicle Identification Number to determine the number of fuel retailer offers.

18. The method as defined in claim 16 wherein the vehicle communications platform is a telematics unit disposed in the vehicle and wherein prior to the receiving step, the method further comprises:
initiating a navigation request by a user at the telematics unit; and
entering the destination of travel at the telematics unit.

19. The method as defined in claim 16 wherein the determining of the route includes the server determining a selection of routes, and wherein the method further comprises:
transmitting the selection of routes to the vehicle communications platform for display on an in-vehicle display; and
receiving, at the server, a user-selected route from the displayed selection of routes.

20. The method as defined in claim 16 wherein each of the number of refueling events is associated with a plurality of the number of fuel retailer offers, and wherein the method further comprises:
prioritizing, by the server, the plurality of the number of fuel retailer offers for display according to an offered fuel price; and
wherein the transmitting includes sending i) a prioritized list based on the total cost, and ii) respective prioritized lists for each of the refueling events, wherein the respective prioritized lists are based on the offered fuel prices.

21. The method as defined in claim 16 wherein the number of refueling events includes a first refueling event and a second refueling event, and wherein the transmitting of the prioritized number of fuel retailer offers further includes:
transmitting some of the prioritized number of fuel retailer offers that are associated with the first refueling event at a first predetermined time as the vehicle travels the route; and
transmitting some other of the prioritized number of fuel retailer offers that are associated with the second refueling event at a second predetermined time as the vehicle travels the route;
the first and second predetermined times being determined using vehicle data including the mileage of the vehicle, a current speed of the vehicle, and the current fuel level.

22. The method as defined in claim 16 wherein prior to transmitting the number of fuel retailer offers to the vehicle communications platform, the method further comprises:
generating a plurality of refueling event plans based upon the calculating of the number of refueling events and the identifying, each refueling event plan being different from each other refueling event plan;
wherein the calculating of the total cost of fuel includes calculating the total cost of fuel for each of the refueling event plans;
wherein the prioritizing including prioritizing the plurality of refueling event plans;
transmitting the prioritized plurality of refueling event plans to the vehicle communications platform; and
determining which of the number of fuel retailer offers to transmit based upon a selected one of the prioritized plurality of refueling event plans.

23. The method as defined in claim 16, further comprising receiving, at the server, a navigation history of the vehicle from an intent engine operatively disposed in the vehicle; and wherein the destination of travel is an inferred destination based on the navigation history.

24. The method as defined in claim 23 wherein the determining of the route is based on the navigation history.

25. The method as defined in claim 16, further comprising:
at the server, obtaining, responsive to the vehicle identifier, additional information including any of vehicle year, vehicle make, vehicle model, vehicle options, owner information, or combinations thereof; and
using the additional information to determine the offers from the plurality of fuel retailers; and wherein one of:
the offers are transmitted to the vehicle communications platform only if the vehicle year and vehicle make meet a predetermined criteria;
the offers are transmitted to the vehicle communications platform only if the vehicle year and vehicle model meet a predetermined criteria; or
the offers are transmitted to the vehicle communications platform only if the vehicle owner information meets a predetermined criteria.

26. A non-transitory, computer-readable storage medium containing computer-readable instructions embodied thereon, the medium comprising:
computer-readable instructions for identifying a plurality of fuel retailers that are within a distance drivable by a vehicle based on a current fuel level of the vehicle and are within a preset deviation of a vehicle location;
computer-readable instructions for determining offers from the plurality of fuel retailers based on a distance of the vehicle from the fuel retailer and an amount of fuel needed by the vehicle, wherein the offers are valid for a set period of time; and
computer-readable instructions for transmitting the offers to a vehicle communications platform of the vehicle.
